(19) United States
(12) Patent Application Publication
(10) Pub. No.: US 2019/0371536 A1
(43) Pub. Date: Dec. 5, 2019

(54) Flexible Supercapacitors and Manufacture Thereof

(71) Applicant: DST Innovations Limited, Bridgend (GB)

(72) Inventors: Anthony Miles, Bridgend (GB); Niladri Vyas, Bridgend (GB)

(73) Assignee: DST Innovations Limited, Bridgend (GB)

(21) Appl. No.: 16/334,078

(22) PCT Filed: Sep. 21, 2017
(86) PCT No.: PCT/GB2017/052828

§ 371 Date: Mar. 18, 2019

(30) Foreign Application Priority Data
Sep. 22, 2016 (GB) 1616131.7

(51) Int. Cl. H01G 11/86; H01G 11/68; H01G 11/80; H01G 11/52; C09J 131/04; C09J 5/06

(52) U.S. Cl. CPC H01G 11/86; H01G 11/68; C09J 5/06; H01G 11/52; C09J 131/04; H01G 11/80

(57) ABSTRACT

This invention describes a layer-by-layer manufacturing process to create fully printable supercapacitors which are highly flexible in nature and can be formed into a specific shape or size allowing use in electronic devices including but not limited to large energy storage systems, electronic equipment and wearable devices. A polymer-based substrate material with superior flexibility is printed onto a release liner followed by deposition of successive layers of active materials. In this manner both the electrodes of a flexible supercapacitor can be prepared separately on the printed substrates before arranging them on top of each other with a thin layer of electrolyte in the middle. The assembled supercapacitors enclosed in the flexible polymer substrate can be removed afterwards from the release liner, providing a fully printed structure with outstanding flexibility. Supercapacitors developed in this manner are fully scalable and can be produced in a roll-to roll production facility.

### FIELD OF INVENTION

This invention relates to methods of manufacturing flexible supercapacitors and to flexible supercapacitors formed by that method.

### BACKGROUND OF THE INVENTION

A supercapacitor is an energy storage device which consists of two electrodes separated by a thin layer of electrolyte. Unlike batteries, which store chemical energy, supercapacitors are capable of storing electrical energy in a high surface area medium. The two electrodes in a supercapacitor can be symmetrical or asymmetrical in nature depending on the materials that are used to manufacture them. For instance if both the electrodes are made of identical materials then the resulting device is symmetrical otherwise it is called an asymmetrical supercapacitor wherein the electrodes are composed of two different types of materials with definite polarities. This type of energy storage device can be charged and discharged very quickly and can typically undergo up to a million charge/discharge cycles offering a longer service life than conventional rechargeable batteries. However, supercapacitors display a lower energy density than most primary and secondary batteries.

The main advantage of supercapacitors provide to a circuit is that they can be charged and release a large amount of energy in a very short time which is necessary in some applications such as but not limited to electric vehicles and power tools. For example, a supercapacitor can be used to charge a secondary battery without having to wait for the battery to be fully charged itself from a stationary power source. In this case the supercapacitor is fully charged in just few seconds from the stationary power supply, then it can be removed from the power source and used to charge the on-board battery while on the move. The electrodes in this type of supercapacitor are mainly made of high surface area materials including but not limited to graphene, activated charcoal, carbon nanotubes, metal oxides, layered oxides, hydroxides, aerogels and nanoporous foams. The open circuit voltage of a supercapacitor is dependent on the nature of electrolyte used within. Aqueous electrolytes can give up to 1.5 V whereas non-aqueous/ionic liquid electrolytes can provide higher open circuit voltages, up to 3.0 V. It is also advantageous in some cases to connect multiple supercapacitors in series or parallel, giving bulky supercapacitor modules with current and voltage outputs tailored to specific uses.

Supercapacitor modules normally come in rigid cylindrical or cuboidal shapes which are not customisable for different applications. There is however a need for energy storage devices that do not have the size, weight and form of traditional supercapacitors. Many such applications require their supercapacitors to be lightweight, flexible, and as thin as possible to restrict the impact of the supercapacitor on the form and weight of the product.

In the majority of supercapacitors currently available on the market the electrodes are made of either activated carbon or metal oxide based materials deposited onto aluminium current collector foils. The two electrodes of such supercapacitors are usually separated by a thin semipermeable polypropylene separator membrane. The semipermeable separator is often soaked in either aqueous or non-aqueous/ionic liquid electrolyte. Supercapacitors that are based on non-aqueous/ionic liquid electrolytes can however be flammable, rendering them hazardous for some applications. Additionally, the presence of metal foil current collectors adds some weight to the finished product, making them too heavy for some applications.

High performance printed supercapacitors have been shown to have the potential to replace currently available bulkier versions but this technology is still in its infancy. For instance, lab-scale small area graphene-based printed supercapacitors have been produced with specific capacitance up to 800 F/g. However, the cost of manufacturing these devices is relatively high as they use gold plated PET (Polyethylene terephthalate) current collectors produced using expensive and restrictive methods such as sputtering. This type of fabrication technique is not practically and economically feasible when it comes to large scale manufacturing of such devices on a roll-to-roll production line.

Printed supercapacitors may be suitable for use in RFID tags, smart cards and wearable devices but they should be fully formable, scalable and flexible for large and small applications. In addition, they have to be low cost and fully customisable to meet customer needs and efficient enough to provide the required performance. Efforts have been made towards the development of printed flexible supercapacitors that can fulfil the above mentioned requirements but none of them is capable of delivering a good balance between performance and formability so far.

US 2011/0235241 A1 discloses a method for developing flexible supercapacitors in which both the electrodes were deposited using either hydrothermal or chemical vapour deposition (CVD) methods on Au-coated Kapton™ sheets. In this manner carbon-based nanomaterials were deposited in fibrous form in order to achieve electrodes with high surface area that led to a specific capacitance of 3.72×10⁻³ F/cm². However, it appears that the cost of manufacturing this type of devices on a larger scale will be relatively high and the maximum size of a single unit will be highly limited.

US 2011/0304955 A1 discloses an inkjet printing method used to produce flexible supercapacitors on PET substrates for wearable technology related applications. A hybrid ink containing single walled carbon nanotubes (SWCNT) and ruthenium oxide is used to form the flexible electrodes on PET substrates separated by a cellulosic membrane. The membrane separator was coated with an electrolyte gel which could be organic or aqueous in nature capable of providing capacitance values between 60 and 65 F/g when combined with the hybrid electrodes. PET is not a fully flexible material, so these supercapacitors will not integrate well with most wearable devices, especially those based on textiles or similar materials. The wearer may also have a distinct sensation wearing such devices caused by the large maximum bend radius of even thin PET. For non-wearable related applications this type of device may be useful, as described in US 2012/0170171 A1, which uses graphene oxide/ruthenium oxide based hybrid ink printed on flexible substrates such as Kapton™ and titanium metal sheets using inkjet printing techniques. The graphene oxide in this case needed to be reduced to graphene in an inert atmosphere which could be seen as a major drawback in terms of technology upscaling. Also, the use of inkjet printing may increase the production cost to a significant amount by increasing the production time.

A process for manufacturing flexible supercapacitors in the form of dispensable tapes called Etapes™ has been disclosed in US 2014/0014403 A1 ^{[4]}. This type of energy storage tapes were made from a ribbon like plastic substrate which provides physical support for the active materials. The active material in this case was carbon nanomaterials and a metal oxide deposited in the form of a printable ink. The active material can be deposited onto the flexible polymer tape using traditional printing techniques such as screen printing, bar coating and rotogravure printing followed by UV curing of the composition to obtain printed electrodes with high surface area. Again, aluminium foil based current collectors were employed increasing the weight of the resulting product. Metallic current collectors are not recommended in devices where acidic or alkaline electrolytes have been used. The aggressive chemicals may cause corrosion of the metallic current collectors which in turn can reduce shelf-life and working lifetime of a device.

It is evident from the prior art that there does not exist currently a practical and economically viable method of producing light weight highly flexible supercapacitors which are capable of integration into many different (e.g. wearable) devices and applications.

### SUMMARY OF THE INVENTION

Aspects of the present invention are defined by the accompanying claims.

Embodiments of the invention may provide supercapacitors that will find application in a number of mainstream and niche applications. This may be achieved by creating a supercapacitor which is formed by sequential deposition of structural and functional layers on top of each other. The result may be a device that is as flexible as a piece of cloth with a performance comparable to a standard rigid device available on the market.

Specific embodiments of the invention may comprise printable supercapacitors, including but not limited to symmetrical and asymmetrical, which can be manufactured via roll-to-roll processes in shapes or sizes tailored to be applicable to the application whilst maintaining their highly flexible lightweight form. In other words, it is possible to roll or fold these supercapacitors very easily, making them ideal for use in high capacity energy storage systems, small electronic devices and as a method of charging batteries. Such supercapacitors may be suitable for most conventional as well as unconventional electronic devices with special design requirements. For instance, grafting supercapacitors onto stretchy and highly flexible materials such as textile or human skin. In this case it is important that the grafted supercapacitors can mimic the physical characteristics of their host materials such as textile or human skin. In other words, they can be stretched or bent with equal force as their host material, without an effect on their electrochemical properties and performance. In a textile-based wearable device these supercapacitors and the textile material may be indistinguishable from each other; the result is an electronic device that will not cause any discomfort or distinctive sensation to the wearer.

Embodiments of the invention may allow up-scaling of production using roll-to-roll techniques, with a potential to produce small to very large energy storage systems that can power a range of electronic devices. All active components in such supercapacitors are printable and scalable using roll-to-roll production techniques. More importantly the encapsulating material (printed substrate) and active layers (current collecting layers and electrodes) in an individual supercapacitor are flexible and printable. Once completed the printed substrates can be removed from the corresponding release liners upon completion of the supercapacitor assembly process. This results in a product that is fully printed with maximum flexibility and an ability for use in non-traditional applications.

Printable flexible supercapacitors containing two electrodes (FIGS. 1a, 1b) and a gel electrolyte 5 have been developed using conventional printing techniques including but not limited to screen printing, flexographic printing, stencil printing, slot dye-coating and rotogravure printing. In case of a symmetrical supercapacitor both the electrodes can be made of the same material which can include but is not limited to graphene, activated charcoal, carbon nanotubes, metal oxides, layered oxides, hydroxides, aerogels and nanoporous foams. This type of supercapacitor does not have polarities at the time of assembly but can be polarised by using an external power supply during the charging process. On the other hand, asymmetrical supercapacitors have two dissimilar electrodes with definite polarities, known as the anode and cathode respectively. The same materials discussed above can be used to manufacture asymmetric supercapacitors but in different combinations. For instance, if the negative electrode or anode is made of a carbon-based nanomaterial then the cathode should be based on a different material other than carbon which could an oxide/hydroxide based compound or something closely related. Before construction the active materials are formulated into inks with a controlled viscosity and active material concentration.

The inks for manufacturing the electrodes may contain powdered materials with diverse morphology which includes rods, spheres, fibres, needles, flakes and tubes in microns to nanometres size range. Smaller sized particles are used to provide an increased surface area therefore ink formulations containing nano-sized particles may provide superior electrochemical performance in terms of charge storage. A polymer binder is normally used for making these inks by dispersing the solid components at various concentrations. It is important to select a polymer binder that maintains the solid and liquid contents of the ink in a homogeneous mixture before application, to do so it may be necessary to add dispersion agents or solvents to the ink. It is also advantageous that the binder is hydrophobic because this is something that minimises the rate of self-discharge in the fabricated supercapacitors, a significant problem for such devices.

The gel electrolyte 5 for both types of supercapacitors may contain a water soluble polymer such as polyvinyl alcohol in an aqueous solution, or a non-aqueous solvent containing an organic compound or a salt in liquid state. The electrolyte should also contain, but is not limited to, a mineral acid or alkali and metal salts capable of releasing ions during the electrochemical reactions. Printable supercapacitors were fabricated on a printed non-conductive substrate 2 which was formed on a release liner 1. It may be necessary to print multiple layers of the substrate material on top of each other to form a layer that is suitably thick, robust and that does not contain any small holes or defects. Failure to do this may result in a substrate that does not prevent ingress of material that might inhibit the operation of the supercapacitor, or allow some or all of the contents of the supercapacitor to spill out. When formed, this printed material should be capable of forming a robust film which can act as a substrate for the deposition of active layers in a sequential manner on each electrode.

A carbon-based current collector ink 3 was first coated onto this printed substrate film before depositing subsequent layers of active materials 4, 7. Unlike aluminium, carbon is relatively stable in the presence of aggressive chemicals thereby giving the device greater durability and working lifetime. The shape and thickness of the electrodes can be tailored to meet the requirements of the cell, or to improve productivity during production, for instance, by reducing waste. During the supercapacitor construction the gel electrolyte 5 can be printed directly onto the electrodes before they are placed together and sealed during the supercapacitor assembly process.

A very thin, permeable separator may be placed in between the electrodes during the supercapacitor assembly process. The material from which the separator is made should be very thin and preferably very flexible. The presence of the separator therefore does not impact upon the lightweight and highly flexible nature of the supercapacitor. If a separator is used it is also possible to coat it with the electrolyte during construction instead of or as well as coating the electrodes with the electrolyte.

The two electrodes 4, 7 with the electrolyte in place and with/without a separator can be attached to each other to make a supercapacitor using an adhesive 6, it is advantageous to use an adhesive that quickly forms a strong flexible seal; it is therefore advantageous to use an adhesive with either a snap cure, fast thermal cure, UV cure, or a pressure sensitive adhesive, although it is also possible to use other adhesive known in the art.

The external electrode terminals for making electrical contacts 8 can be made to fit the nature of application. It is advantageous that the electrodes are robust enough to form reliable contacts with the electric device even after constant connection/disconnection cycles. It might therefore be advantageous to form the external electrode terminals using a robust electrically conductive material such as a metal particle based conductive ink, containing for example but not limited to silver, nickel, or mixtures thereof. It might also be advantageous to use highly conductive metal foil or tape attached to the positive and negative terminals of the supercapacitor.

### BRIEF DESCRIPTION OF THE DRAWINGS

FIGS. 1a and 1b show two respective sides (e.g. anode and cathode) of a supercapacitor in an embodiment of the present invention.

FIG. 2 shows a fabrication method for a supercapacitor according to embodiments of the present invention.

FIG. 3 shows a roll-to-roll process for fabricating a fully printable, flexible supercapacitor according to embodiments of the present invention.

FIGS. 4A to 4D show flexible supercapacitors formed in various shapes according to embodiments of the present invention.

### DETAILED DESCRIPTION

A method of manufacturing printable symmetrical and asymmetrical supercapacitors according to an embodiment of the invention will now be described. These supercapacitors demonstrate a superior flexibility that comes from the use of a highly flexible printed substrate, printed electrodes, and gel electrolyte. This printed substrate 2 is made from a film forming polymer and is deposited onto a sheet of release liner 1 (step 201) using a conventional printing technique including but not limited to screen printing, flexographic printing, bar coating, rotogravure printing and slot dye coating. The printed polymeric film is then cured appropriately, this may include the use of, but is not limited to, a thermal oven, near-infrared energy source, actinic radiation, photonic curing, or any other technique known in the art. The result is an extremely flexible and robust substrate which is capable of undergoing numerous flex cycles without performance degradation. The as-prepared flexible substrate should be suitable for deposition of one or more layers of active materials necessary for manufacturing individual supercapacitor electrodes. Importantly, the substrate material should be chemically inert so that it does not react with the chemicals present in the deposited layers, electrolyte gel or dissolved/ambient gases. The active layers are formulated as inks that can be printed using conventional techniques, including but not limited, to screen printing, flexographic printing, rotogravure printing, slot dye, and bar coating.

Any one of a number of electrode ink systems may be used; broadly these include, but are not limited to, a conductive ink and an electrode ink. In case of asymmetric supercapacitors two types of electrode inks, for making the anode and cathode respectively, are required. The conductive ink can be made from but is not limited to carbon-based materials, such as graphite, graphene, carbon black, single-walled nanotubes, multi-walled nanotubes, or any other carbon particle known in the art. The conductive ink can also be made from but is not limited to metal particles, a mixture of metallic and non-metallic particles, and particles of metal alloys.

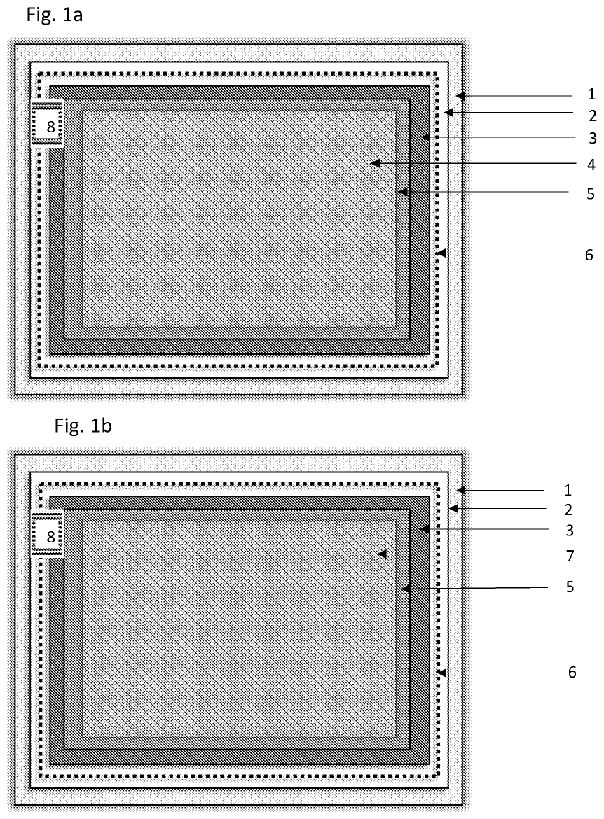

The conductive inks can be used for depositing a current collection layer 3 on top of the flexible polymer substrate. It is advantageous that the layer is common for both the electrodes (FIGS. 1a, 1b) as it acts as an electrically conductive under layer for both the electrodes 4, 7, facilitating charge collection and transfer processes occurring at the polarised electrodes. In one case dried films produced from a modified conductive carbon ink demonstrated electrical resistance between 15-20Ω which is adequate for charge extraction from the polarised anode of a supercapacitor to its cathode.

It may be advantageous to add a wetting agent to the flexible substrate to aid adhesion and accurate deposition of the conductive ink. Wetting agents or mixtures of wetting agents include but are not limited to ethylene glycol, propylene glycol, glycol-based chemicals, or mixtures thereof. Following deposition and curing of the conductive ink the next process is the deposition of the electrode materials 4/7. The electrode inks 4/7 are deposited using a conventional printing techniques including but not limited to screen printing, flexographic printing, bar coating, rotogravure printing and slot dye coating and cured using techniques known to the art, including thermal, near-infrared, photonic curing techniques or exposure to actinic radiation. Electrolyte gel 5 was then deposited on the cured electrodes or on a separator, if used, or on both. The two sides of the supercapacitor electrodes, and if required the separator, were then put together to form a functional supercapacitor with the electrolyte gel in the middle. The separator is a semipermeable membrane that allows the electrolyte ions to diffuse through but keeps the two electrodes from touching. A separator can be made of any suitable material, including but not limited to filter paper and polypropylene film.

The electrolyte gel 5 for supercapacitors can be prepared using an aqueous or non-aqueous solvent which may contain an appropriate polymer gelling agent and one of the following compounds including but not limited to mineral acids, alkali or liquid salts. An aqueous electrolyte might include polymers such as but is not limited to polyvinyl alcohol (PVA), polyacrylic acid, methyl cellulose and polyethylene oxide mixed with one of the following acids or alkalis such as but not limited to sulphuric acid, nitric acid, phosphoric acid, sodium hydroxide, potassium hydroxide and ammonium hydroxide respectively. The non-aqueous electrolyte may contain a suitable concentration of ions liberated from ionic liquid compounds dissolved in an appropriate organic medium such as but not limited to acetonitrile, y-butyrolactone, dimethyl ketone and propylene carbonate. The ionic liquid compounds in this case may include one the following but not limited to imidazolium, pyrrolidinium and asymmetric aliphatic quaternary ammonium salts of anions such as tetrafluoroborate, trifluoromethanesulfonate, bis(trifluoromethanesulfonyl)imide, (bis(fluorosulfonyl)imide and hexafluorophosphate. Advantageously the concentration of ions in the electrolyte medium may be within 1-10M for optimised performance.

Both the electrodes of an assembled supercapacitor are then stuck together using an appropriate adhesive 6, including but not limited to epoxy-based adhesives, silicone adhesives, and cyanoacrylates. The adhesives are used to achieve a flexible air-tight seal leaving only the terminals of the electrodes outside for making electrical contacts 8. A silver-based ink can be used in this case for printing the contact. After the sealing process the assembled supercapacitors are removed from the release liners and are ready to use.

### Fabrication Method

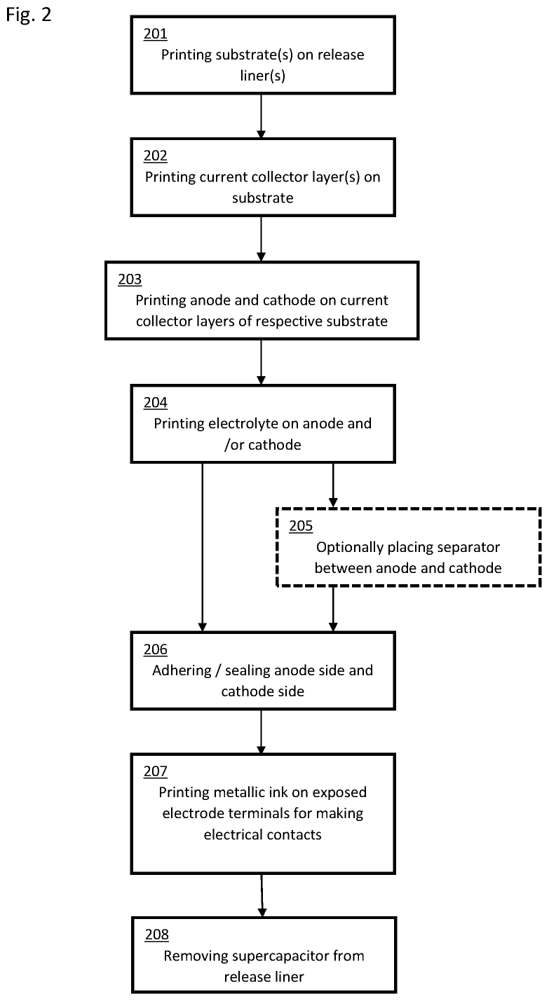

A fabrication method in an embodiment of the invention will now be described with reference to FIG. 2. A printed symmetrical supercapacitor based on activated carbon was prepared using flexible polymer substrates. Flexible polymer substrates were used for making both the electrodes for said device. In this example amine-based polymeric material was used as a precursor for preparing those flexible substrates of approximately 50 microns thickness printed onto two separate release liners using screen printing technique (step 201).

Printed substrates were then cured in a convection oven at 120° C. for 15 minutes and then allowed to cool to room temperature. The current collection layers were then formed by depositing a carbon-based ink at a thickness of approximately 15 microns on both substrates using a screen printing technique (step 202). The carbon-based current collection layer was cured at 90° C. for 15 minutes and allowed to cool to room temperature.

This was followed by screen printing electrode ink of approximately 20 microns thickness on both substrates, to form an anode and a cathode respectively (step 203). The carbon-based ink for making symmetrical electrodes was prepared by adding 60 wt % activated carbon (average particle size 10 microns) and 10 wt % carbon black powder (average particle size <3 microns) to PVDF binder followed by stirring the mixture at 2500 rpm for two hours. The as-printed electrodes were then dried at 120° C. for 10 minutes and allowed to cool to room temperature.

A thin layer of gel electrolyte was then deposited on the electrodes (step 204). The gel electrolyte was made of NaCl (6N) in aqueous PVA (30 wt %). As described above, a separator may then be placed between the anode and the cathode (step 205).

The assembly process was then finished by adhering the anode side and cathode side together (step 206), by quickly applying a flexible epoxy-based glue to the edges of the electrodes to seal the supercapacitor, leaving the electrode terminals exposed. A silver-based ink was next used to print electrical contacts onto the exposed terminals which were then air dried for 10 minutes (step 207). The as-formed supercapacitors were then removed from their release liners (step 208) in order to obtain fully printable and extremely flexible energy storage devices.

### Roll-to-Roll Fabrication Method

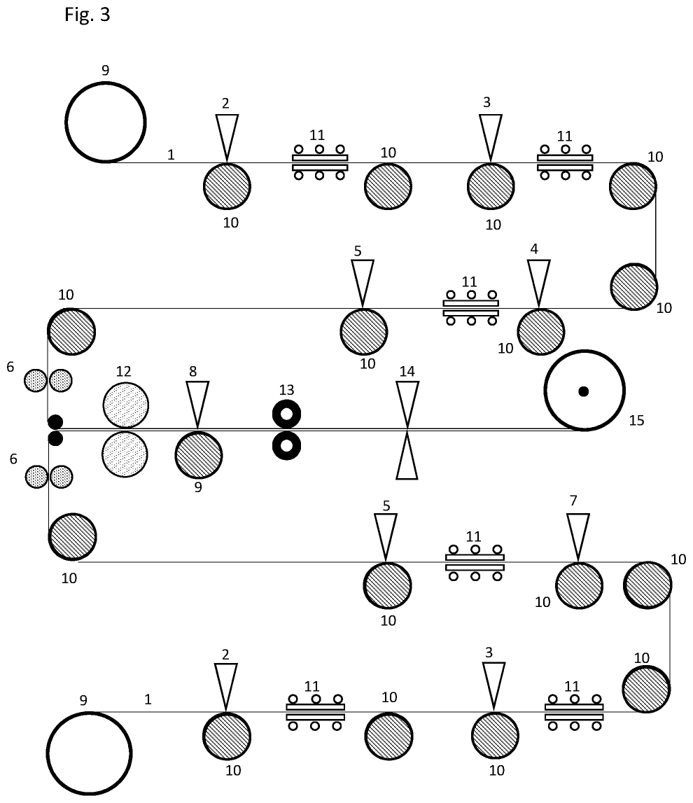

The above type of fully printed supercapacitors may be manufactured on a roll-to-roll production line through a continuous process. FIG. 3 illustrates manufacturing of asymmetric supercapacitors on a roll-to-roll production line. Two electrodes namely anode and cathode were printed on a two separate lines followed by their assembly on a third line. Line one and two contain four screen printers and three near infrared (NIR) ovens each in order to achieve sequential deposition of active materials. On Line one the printing process started with continuous supply of the release liner onto a conveyor belt 10 from a feeder 9 followed by screen printing of polymer precursor for the flexible substrate material 2. The printed wet coating was then passed through an NIR oven 11 for rapid curing of the flexible polymer substrate before being sent towards another screen printer which prints a layer of conductive carbon-based current collector ink 3 onto the dried flexible substrate. Carbon-based current collector ink was also dried using another NIR oven. After this the anode ink 4 was screen printed onto the flexible substrate and dried by passing through an NIR oven. An electrolyte gel 5 was then screen printed onto the dried anode before redirection towards the assembly line to put together with the cathode part containing cathode ink 7. The cathode part on Line two was prepared in the same way as the anode part which can be seen in FIG. 3. Before the assembly process both the anode and cathode parts were passed through in-line adhesive dispensers 6 to apply a thin snap cure adhesive layer along the boundaries of anode and cathode parts in order to achieve an air tight seal in the end of the assembly process. On the assembly line anode and cathode were placed on top of each other and passed through a pair of heated pressure rollers 12 in order to achieve a stronger seal. The sealed device was then passed through a screen printer 8 to print a metallic ink for making electrical contacts on both anode and cathode ends followed by device encapsulation using a hermetic membrane 13. The encapsulated device in the form of a long sheet was then cut at predetermined lengths using a cutter 14 and wrapped around a collection reel 15.

### Example Shapes

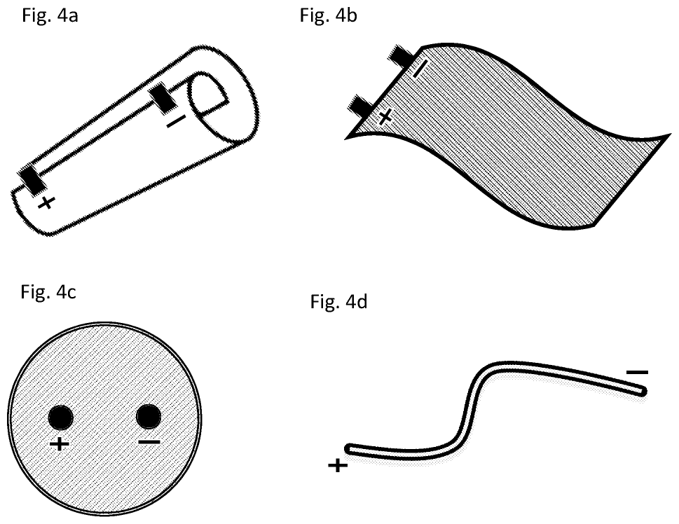

Roll-to-roll printed fully flexible supercapacitors can be produced in different shapes as shown in FIG. 4. Some possible shapes include roll cylinders 16, thin flexible sheets 17, circular sheets 18, and ribbons 19.

### Alternative Embodiments

Combinations of features from any embodiment as described previously may be used in combination and may nevertheless fall within the scope of the present invention. Alternative embodiments may be contemplated on reading the above disclosure, which may nevertheless fall within the scope of the invention as defined by the accompanying claims.

1. A method of fabricating a flexible supercapacitor, the method comprising:
a. forming a first substrate on a first release liner and a second substrate on a second release liner;
b. forming at least one current collector layer on each of the first and second substrates;
c. forming an anode side by forming an anode on the current collector layer of the first substrate;
d. forming a cathode side by forming a cathode on the current collector layer of the second substrate;
e. depositing an electrolyte on one or both of the anode and cathode;
f. adhering and sealing the anode side and the cathode side together such that the anode and cathode face one another with the electrolyte in between, leaving electrode terminals exposed for connection; and
g. removing the flexible supercapacitor from the release liners.

2. (canceled)

3. The method of claim 1, wherein the first and second substrates are formed by printing substrate material onto the first release liner and the second release liner respectively.

4. The method of claim 3, wherein the printed substrate material is a film forming polymer.

5. (canceled)

6. (canceled)

7. (canceled)

8. The method of claim 3, wherein the printed substrate material is cured following printing.

9. (canceled)

10. (canceled)

11. (canceled)

12. The method of claim 1, wherein the current collector layers are formed by printing current collector ink on the first substrate and second substrate.

13. (canceled)

14. The method of claim 1, wherein the current collector layers are made from carbon-based materials.

15. (canceled)

16. The method of claim 1, wherein the current collector layers are made from at least one of metal particles, mixtures of metallic and non-metallic particles, or particles of metal alloys.

17. (canceled)

18. The method of claim 12, wherein a wetting agent is added to the substrate to aid adhesion and accurate deposition of the current collector ink.

19. (canceled)

20. The method of claim 12, wherein the printed current collector ink is cured or dried to form the current collector layers.

21. (canceled)

22. (canceled)

23. The method of claim 1, wherein the anode and cathode are formed by printing.

24. (canceled)

25. The method of claim 23, wherein one or more inks for the printing of the anode or cathode comprise powdered materials or particles.

26. (canceled)

27. The method of claim 23, wherein one or more inks for the printing of the anode or cathode include a polymer binder.

28. The method of claim 23, wherein one or more inks for the printing of the anode or cathode include a hydrophobic binder.

29. The method of claim 1, wherein a material of at least one of the anode and cathode is carbon-based.

30. The method of claim 1, wherein a material of at least one of the anode and cathode comprises an oxide/hydroxide base compound.

31. (canceled)

32. (canceled)

33. The method of claim 1, wherein the electrolyte is deposited by printing.

34. The method of claim 1, wherein the electrolyte is an electrolyte gel.

35. The method of claim 1, wherein the electrolyte comprises a water soluble polymer in an aqueous solution.

36. (canceled)

37. (canceled)

38. (canceled)

39. (canceled)

40. (canceled)

41. The method of claim 1, wherein the electrolyte comprises a non-aqueous solvent and a polymer.

42. (canceled)

43. (canceled)

44. (canceled)

45. (canceled)

46. The method of claim 1, wherein prior to adhering the anode side and cathode side, a separator is placed between the anode and cathode.

47. The method of claim 46, wherein the separator is a thin, semipermeable membrane.

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)
